(19) United States
(12) Patent Application Publication
(10) Pub. No.: US 2026/0353266 A1
(43) Pub. Date: Nov. 5, 2026

(54) METERING APPARATUS

(71) Applicant: Landis+Gyr Technology, Inc., Alpharetta, GA (US)

(72) Inventors: Justin MATTHEWS, Sutherland , NSW (AU); Paul COLLINS, Bexley, NSW (AU); Matthew Donald KARLGAARD, Brainerd, MN (US); Christopher Sean CALVERT, Roswell, GA (US)

(21) Appl. No.: 19/482,511

(22) PCT Filed: May 9, 2024
(86) PCT No.: PCT/US2024/028480

§ 371 Date: Nov. 7, 2025

(30) Foreign Application Priority Data
May 11, 2023 (GB) 2307015.4

(51) Int. Cl. H04W 48/18

(52) U.S. Cl. CPC H04W 48/18

(57) ABSTRACT

A metering apparatus (14a-14c) comprising a communications device (22) comprising a first connective mode and a second connective mode, wherein in the first connective mode, the communications device (22) is configured to connect to a cellular network (12) for transmission and/or reception of data to and/or from the cellular network (12) and in the second connective mode, the communications device (22) is configured to connect to a wireless network (2a) for transmission and/or reception of data to and/or from the wireless network (2a), the wireless network (2a) being configured to use one or more unlicensed frequency bands below 1 GHz and a control apparatus (18) configured to adaptively operate the communications device (22) in the first connective mode and/or the second connective mode based on at least one of: an availability of each of the cellular network (12) and/or the wireless network (2a) and/or a connection priority assigned to each of the cellular network (12) and/or the wireless network (2a).

### FIELD

The present disclosure relates to a metering apparatus and an associated system and method.

### BACKGROUND

Metering apparatuses may be deployed at businesses, homes, and other premises for measuring consumption of resources, such as electricity, water, and gas. While some metering apparatuses may provide only basic metering functions, other metering apparatuses, known in the art as “smart meters”, may provide more advanced functionality, such as control and communications functionality.

A plurality of metering apparatuses may be connected to a head-end system to transmit data to the head-end system and/or receive data from the head-end system. The data may relate to a consumption of resources and/or controlling of a resource. The transmission of data relating to consumption of metered resources may simplify automated billing, reduce operational costs, and may enable advanced analytics of resource consumption.

For example, in a cellular system, the metering apparatuses may be connected to a cellular network for two-way data transmission with the head-end system.

In another example, a plurality of metering apparatuses may be connected to a gateway device. The gateway device may collect the data transmitted by one or more of the metering apparatuses and transmit the collected data to the head-end system. Alternatively, the gateway device may transmit data received from the head-end system to one or more of the metering apparatuses. The metering apparatuses and the gateway device may be implemented as a wireless radiofrequency (RF) network. The gateway device may be connected to the head-end system via a cellular network.

Operators of cellular networks typically apply charges for transferring data. As such, the operational costs of the cellular system may be increased compared to the operational costs of the mesh network. However, in a RF network, an installation and maintenance of a specific network device, such as a gateway device and/or a router, may be required. This may lead to increased costs for installing the RF network.

When installing a metering apparatus, there may be a need to decide whether to install the metering apparatus as part of a cellular system or a RF network. For example, when the metering apparatus has been installed as part of the cellular system, it may be difficult to adapt the metering apparatus for use in a RF network, when the RF network becomes available.

It is therefore an aim of at least one embodiment of at least one aspect of the present disclosure to obviate or at least mitigate at least one of the above identified shortcomings.

### SUMMARY

According to a first aspect of the present disclosure there is provided a metering apparatus comprising a communications device comprising a first connective mode and a second connective mode, wherein in the first connective mode, the communications device is configured to connect to a cellular network for transmission and/or reception of data to and/or from the cellular network and in the second connective mode, the communications device is configured to connect to a wireless network for transmission and/or reception of data to and/or from the wireless network, the wireless network being configured to use one or more unlicensed frequency bands below 1 GHz and a control apparatus configured to adaptively operate the communications device in the first connective mode and/or the second connective mode based on at least one of: an availability of each of the cellular network and/or the wireless network and/or a connection priority assigned to each of the cellular network and/or the wireless network.

By configuring the control apparatus to adaptively operate the communications device in the first connective mode and/or the second connective mode, the metering apparatus may be operated as a cellular endpoint device, an endpoint device of the wireless network or a gateway device. The installation of a specific network device, such as a gateway device and/or a router, may be avoided, which in turn may reduce installation and/or maintenance costs of a wireless network. Additionally or alternatively, when installing the metering apparatus at a site, there may be no need to decide whether to install the metering apparatus as part of a cellular network or a wireless network. By configuring the control apparatus to adaptively operate the communications device in the first connective mode and/or the second connective mode based on at least one of: an availability of each of the cellular network and/or the wireless network and/or a connection priority assigned to each of the cellular network and/or the wireless network, the control apparatus may be able to decide whether the apparatus becomes a part of the cellular or the wireless network, e.g. based on the availability of each of the cellular network and/or the wireless network and/or the connection priority assigned to each of the cellular network and/or the wireless network. For example, a connection priority assigned to the wireless network may be higher than a connection priority assigned to the cellular network. As such, the control apparatus may be configured to operate the communications device in the second connective mode and/or to attempt a connection of the communications device to the wireless network, e.g. before attempting a connection to the cellular network. This may allow for a reduction in connections to a cellular network, which in turn may reduce operational costs and/or provide an increased flexibility in a strategy for installing the metering apparatus.

Alternatively, the connection priority assigned to the cellular network may be higher than the connection priority assigned to the wireless network. As such, the control apparatus may be configured to operate the communications device in the first connective mode and/or to attempt a connection of the communications device to the cellular network, e.g. before attempting a connection to the cellular network. This may reduce a number of hops and/or a latency of a system comprising the apparatus and/or provide an increased flexibility in a strategy for installing the metering apparatus.

The one or more unlicensed frequency bands may comprise one or more industrial, scientific and medical (ISM) frequency bands below 1 GHz. The wireless network may comprise an IEEE 802.15 network, such as an IEEE 802.15.4 network. For example, the wireless network may comprise a Wireless Smart Utility network (Wi-SUN) or IEEE 802.15.4g Smart Utility Network (SUN). Alternatively, the wireless network may comprise an IEEE 802.11 network.

For example, when the communications device is operated in the first connective mode and/or connected to the cellular network, the apparatus may be configured to operate as a cellular endpoint device or a gateway device. When the apparatus is operated as the gateway device, the control apparatus may be configured to also operate the communications device in the second mode.

When the control apparatus operates the communications device in the first and second connective modes, the control apparatus may be configured to switch operation of the communications device between the first and second connective modes. The control apparatus may be configured to switch operation of the communications device between the first and second connective modes at a rate that allows for simultaneous connection, e.g. substantially simultaneous connection, of the communications device to the cellular network and the wireless network.

Alternatively, the control apparatus may be configured to simultaneously operate, e.g. substantially simultaneously operate, the communications device in the first and second connective modes.

When the communications device is operated in the second connective mode and/or connected to the wireless network, the apparatus may be configured to operate as an endpoint of the wireless network.

The control apparatus may be configured to operate the communications device in the first connective mode or the second connective mode in an order determined by a ranking of the cellular network and/or the wireless network. The control apparatus may be configured to operate the communications device to attempt a connection of the communications device to the cellular network or the wireless network in the order determined by the ranking of the cellular network and/or the wireless network.

The control apparatus may be configured to repeat operating the communications device in the first connective mode or the second connective mode and/or to repeat operating the communications device to attempt a connection of the communications device to the cellular network or the wireless network, e.g. in the order determined by the ranking of the cellular network and/or the wireless network, e.g. until the communications device is connected to at least one of the cellular network and the wireless network.

The control apparatus may be configured to rank the cellular network and/or the wireless network according to the connection priority assigned to each of the cellular network and/or the wireless network. The control apparatus may be configured to rank the cellular network and/or the wireless network according to a second parameter. The second parameter may also be referred to as a parameter or further parameter. The second parameter may be associated with each of the cellular network and/or the wireless network. The second parameter may be indicative of the availability and/or a quality of each of the cellular network and/or the wireless network. The control apparatus may be configured to rank the cellular network and/or wireless network according to the connection priority prior to ranking the cellular network and/or wireless network according to the second parameter.

The control apparatus may be configured to operate the communications device to scan for a/the cellular network and/or a/the wireless network. For example, when the wireless network and/or the cellular network is detected, the control apparatus may be configured to determine a second parameter associated with each of the detected cellular network and/or the wireless network. The control apparatus may be configured to update the ranking of the cellular network and/or the wireless network based on the determined second parameter associated with each the detected cellular network and/or the wireless network.

The control apparatus may be configured to operate the communications device in the first connective mode or the second connective mode in an order determined by the updated ranking of the cellular network and/or the wireless network. The control apparatus may be configured to operate the communications device to attempt a connection of the communications device to the cellular network or the wireless network in the order determined by the updated ranking of the cellular network and/or the wireless network.

For example, when the control apparatus detects that at least one of the cellular network and the wireless network is ranked higher in the updated ranking than at least one other of the cellular network and wireless network that the communications device is connected to, the control apparatus may be configured to continue operating the communications device in the first connective mode, for example when the apparatus operates as a gateway and an endpoint device is connected to the apparatus. This may prevent an interruption of a connection between the gateway device and the endpoint device.

Alternatively, e.g. when the control apparatus detects that the at least one of the cellular network and the wireless network is ranked higher in the updated ranking than at least one other of the cellular network and wireless network that the communications device is connected to, the control apparatus may be configured to operate the communications device in the first connective mode or the second connective modes to attempt a connection of the communications device to the at least one of the wireless network and the cellular network.

The at least one other of the cellular network and the wireless network may be ranked the highest in the updated ranking. This may allow for a connection of the communications device to a cellular or wireless network having a higher or even the highest priority.

The control apparatus may be configured to remove at least one of the cellular network and the wireless network associated with a second parameter that equals zero from the ranking and/or the updated ranking, unless a second parameter associated with each of the cellular network and/or wireless network equals zero. This may ensure that the ranking and/or the updated only includes a cellular network and/or a wireless network that is available for connection to the communications device.

The control apparatus may be configured to operate the communications device in the first connective mode and/or the second connective mode, e.g. based on one or more system operator requirements. The operation of the communications device based on the one or more system operator requirements may overwrite the operation of the communications device based on the at least one of: the availability of each of the cellular network and/or the wireless network and/or the connection priority assigned to each of the cellular network and/or the wireless network.

The communications device may comprise a modem comprising the first and second connective modes. Alternatively, the communications device may comprise a first modem comprising the first connective mode and a second modem comprising the second connective mode.

According to a second aspect of the present disclosure there is provided a system comprising a plurality of metering apparatuses, at least one or each of the plurality of metering apparatuses comprising a metering apparatus according to the first aspect.

At least one apparatus of the plurality of metering apparatuses may be operated in the first or second connective mode. At least one other apparatus may be operated in the first and second connective modes.

The system may comprise or define a cellular network. The cellular network may be or comprise a Low Power Wide Area Network (LPWAN), such as a Long-Term Evolution Machine LTE-M network, LTE-Cat M network or the like.

Alternatively, the system may comprise or define a wireless network. The wireless network may comprise a point-to-point network or a mesh network. The wireless network may be configured to use one or more unlicensed frequency bands below 1 GHz. The one or more unlicensed frequency bands may comprise one or more industrial, scientific and medical (ISM) frequency bands below 1 GHz. The wireless network may comprise an IEEE 802.15 network, such as an IEEE 802.15.4 network. For example, the wireless network may comprise a Wireless Smart Utility network (Wi-SUN) or IEEE 802.15.4g Smart Utility Network (SUN). Alternatively, the wireless network may comprise an IEEE 802.11 network.

According to a third aspect of the present disclosure there is provided a method of operating a metering apparatus according to the first aspect, the method comprising adaptively operating the communications device in the first connective mode and/or the second connective mode based on at least one of:
an availability of each of the cellular network and/or the wireless network; and/or
a connection priority assigned to each of the cellular network and/or the wireless network.

The method may comprise operating the communications device in the first connective mode or the second connective mode in an order determined by a ranking of the cellular network and/or the wireless network.

The method may comprise operating the communications device to attempt a connection of the communications device to the cellular network or the wireless network in the order determined by the ranking of the cellular network and/or the wireless network.

The method may comprise repeating the step of operating the communications device in the first connective mode or the second connective mode and/or the step of operating the communications device to attempt a connection of the communications device to the cellular network or the wireless network in the order determined by the ranking of the cellular network and/or the wireless network, e.g. until the communications device is connected to at least one of the cellular network and the wireless network.

The method may comprise ranking the cellular network and/or the wireless network according to the connection priority assigned to each of the cellular network and/or the wireless network. The method may comprise ranking the cellular network and/or the wireless network according to a second parameter. The second parameter may be associated with each of the cellular network and/or the wireless network. The second parameter may be indicative of the availability and/or a quality of each of the cellular network and/or the wireless network. The method may comprise ranking the cellular network and/or wireless network according to the connection priority prior to ranking the cellular network and/or wireless network according to the second parameter.

The method may comprise operating the communications device to scan for the cellular network and/or the wireless network. For example, when the wireless network and/or the cellular network is detected, the method may comprise determining the second parameter associated with each the cellular network and/or the wireless network. The method may comprise updating the ranking of the cellular network and/or the wireless network based on the determined second parameter associated with each the cellular network and/or the wireless network.

The method may comprise operating the communications device in the first connective mode or the second connective mode in an order determined by the updated ranking of the cellular network and/or the wireless network. The method may comprise operating the communications device to attempt a connection of the communications device to the cellular network or the wireless network in the order determined by the updated ranking of the cellular network and/or the wireless network.

For example, when at least one of the cellular network and the wireless network is ranked higher in the updated ranking than at least one of the cellular network and wireless network that the communications device is connected to, the method may comprise may continuing operating the communications device in the first connective mode, for example when the apparatus operates as a gateway and an endpoint device is connected to the apparatus. This may prevent an interruption of a connection between the gateway device and the endpoint device.

Alternatively, e.g. when at least one of the cellular network and the wireless network is ranked higher in the updated ranking than the at least one of the cellular network and wireless network that the communications device is connected to, the method may comprise operating the communications device in the first connective mode or the second connective modes to attempt a connection of the communications device to the at least one other of the wireless network and the cellular network.

The at least one of the cellular network and the wireless network may be ranked the highest in the updated ranking. This may allow for a connection of the communications device to a cellular or wireless network having a higher or even the highest priority.

The method may comprise removing at least one of the cellular network and the wireless network associated with a second parameter that equals zero from the ranking and/or the updated ranking, unless a second parameter associated with each of the cellular network and/or wireless network equals zero. This may ensure that the ranking and/or the updated only includes a cellular network and/or a wireless network that is available for connection to the communications device.

The method may comprise operating the communications device in the first connective mode and/or the second connective mode, e.g. based on one or more system operator requirements. The operation of the communications device based on the one or more system operator requirements may overwrite the operation of the communications device based on the at least one of: the availability of each of the cellular network and/or the wireless network and/or the connection priority assigned to each of the cellular network and/or the wireless network.

According to a fourth aspect of the present disclosure there is provided a computer program comprising instructions to cause the metering apparatus according to the first aspect to execute the steps of the method according to the third aspect.

According to a fifth aspect of the present disclosure there is provided a computer-readable medium having stored thereon the computer program according to the fourth aspect.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF DRAWINGS

These and other aspects of the present disclosure will now be described, by way of example only, with reference to the accompanying drawings, wherein:

FIG. 1A schematically depicts an exemplary system comprising a wireless network;

FIG. 1B schematically depicts another exemplary system comprising a wireless network;

FIG. 2 schematically depicts an exemplary cellular system;

FIG. 3 schematically depicts exemplary metering apparatuses according to an embodiment;

FIG. 4 schematically depicts exemplary metering apparatuses according to another embodiment;

FIG. 5 is a flow chart illustrating in overview a process of operating at least one of the metering apparatuses of FIG. 3 or 4; and

FIG. 6 is a flow chart illustrating in overview another process of operating at least one of the metering apparatuses of FIG. 3 or 4.

### DETAILED DESCRIPTION OF DRAWINGS

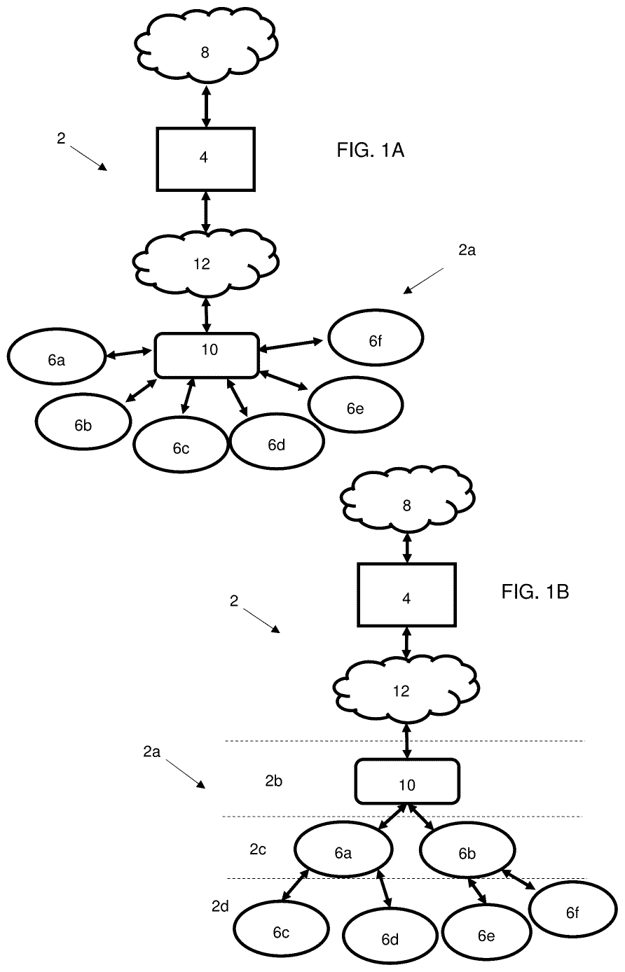

FIG. 1A schematically shows an exemplary system 2 comprising a wireless network 2a, such as a wireless point-to point network. In this embodiment, the wireless network 2a is implemented as a star formation. In this embodiment, the wireless network 2a uses one or more unlicensed frequency bands below 1 GHz, such as one or more industrial, scientific and medical (ISM) frequency bands below 1 GHz. The ISM frequency bands may comprise 863 MHz to 876 MHZ, 902 MHZ to 926 MHz, 902 MHz to 907.5 MHz, 920 MHz to 928 MHZ, 915 MHz to 926 MHz, 920 MHz to 926 MHz, 470 MHz to 510 MHz, 779 MHz to 787 MHZ, 920.5 MHz to 924.5 MHz, 865 MHz to 867 MHz, 866 MHz to 869 MHz, 920 MHz to 925 MHz, 902 MHz to 928 MHz, 915 MHz to 928 MHz, 917 MHz to 923.5 MHz, 915 MHz to 918 MHz, 919 MHz to 923 MHz, and/or the like. It will be appreciated that different frequency bands may be used in different countries, regions or states. The wireless network 2a may also be referred to as a radiofrequency (RF) network. In some embodiments, the wireless network 2a may be implemented as an IEEE 802.15 network, such as IEEE 802.15.4 network. However, it will be appreciated that in other embodiments, the wireless network may be implemented according to another technical standard, such as a network according to the IEEE 802.11 standard.

Although in this embodiment, the wireless network 2a is implemented as a point-to-point network, it will be appreciated that in other embodiments, the wireless network may be differently implemented. For example, in such other embodiments, the wireless network may be implemented as a mesh network or the like.

The system 2 may comprise a head-end system 4. The head-end system 4 may function as a central processing system that transmits and/or receives data to and/or from a plurality of endpoint devices 6a-6f. The data may comprise one or more streams of data, one or more data packets, one or more messages, one or more signals, one or more control signals and/or the like. Each of the endpoint devices 6a-6f may define a node of the wireless network 2a. The head-end system 4 may be configured to process the data received from one or more of the endpoint devices 6a-6f and/or to generate the data transmitted to one or more of the endpoint devices 6a-6f. In some embodiments, the head-end system 4 may be coupled to a further system 8, such as a cloud-based system, for generating and/or processing the data. Although FIG. 1A shows six endpoint devices 6a-6f, it will be appreciated that in other embodiments the system may comprise more or less than six endpoint devices. For example, the system may comprises tens or hundreds of endpoint devices.

The system 2 may comprise a gateway device 10. The gateway device 10 and the endpoint devices 6a-6f define and/or are part of the wireless network 2a. The gateway device 8 may define a root node of the wireless network 2a. The gateway device 10 may be configured to communicate with one or more of the endpoint devices 6a-6f to perform one or more operations, such as retrieving data from the endpoint devices 6a-6f and/or transmitting data to the endpoint devices 6a-6f. The data may be routed along a path by hoping between each of the endpoint devices 6a-6f and the gateway device 10. In the example shown in FIG. 1, a single hop may be necessary between each of the endpoint devices 6a-6f and the gateway device 10. However, it will be appreciated that in other embodiments, the endpoint devices and/or gateway device may be differently arranged and/or more than one hop may be necessary to route data between the gateway device and an endpoint device.

The gateway device 10 may be configured to transmit and/or receive data to and/or from the head-end system 4. For example, the gateway device 10 may collect the data transmitted by one or more of the endpoint devices 6a-6f and transmit the collected data to the head-end system 4. The gateway device 10 may be configured to transmit and/or receive the data to and/or from the head-end system 4 via another network (not shown in FIG. 1), such as the Internet, an intranet or another data communication network. The gateway system 10 may be configured to access the other network by connecting to a cellular network 12. The cellular network 12 may be a Low Power Wide Area Network (LPWAN), such as a Long-Term Evolution Machine LTE-M network, LTE-Cat M network or the like. The cellular network 12 may also be referred to as a mobile network. Although a single gateway device 10 is shown in FIG. 1A, it will be appreciated that in other embodiments, the system, e.g. the wireless network, may comprise more than one gateway device.

FIG. 1B schematically shows another exemplary system 2 comprising a wireless network 2a. The system 2 shown in FIG. 1B is similar to that shown in FIG. 1B. As such, any features described in relation to the system 2 shown in FIG. 1A may also apply to the system 2 shown in FIG. 1B. Only differences will be described in the following.

In this embodiment, the wireless network 2a is implemented as a wireless mesh network. The wireless network 2a may comprise a full mesh topology, e.g. where any node can communicate with any node within range, or a partial mesh topology with more limited or selected connectivity between nodes. In this embodiment, the wireless network 2a may be implemented according to the IEEE 802.15.4 standard. For example, the wireless network 2a may comprise a Wireless Smart Utility network (Wi-SUN) or IEEE 802.15.4g Smart Utility Network (SUN).

The wireless network 2a may be effectively provided in layers 2c-2d, as indicated in FIG. 1B. In this example, the gateway device 10 forms the first layer 2b of the wireless network 2a. Endpoint device 6a, 6b that are communicably coupled directly to the gateway device 10 form a second layer 2c of the wireless network 2a. Similarly, endpoint devices 6c-6f that are communicably coupled to the wireless network 2a through the second layer 2c form the third layer 2d of the wireless network 2a. The endpoint devices 6a-6f are configured to communicate with each other such that data may be exchanged between the endpoint devices 6a-6f. For data to propagate from the gateway device 10 to the third layer 2d of the wireless network 2a would require two “hops” of the data. However, it will be appreciated that in other embodiments, the wireless network may comprise more or less than three layers and/or more or less than two hops may be necessary for data to propagate in the wireless network.

The head-end system 4 may be configured to communicate data to some or all of the gateway device 10 and/or the endpoint devices 6a-6f, e.g. using unicast transport of data, multicast transport of data or another data transport process.

Although FIG. 1B shows six endpoint devices 6a-6f, it will be appreciated that in other embodiments the system may comprise more or less than six endpoint devices. For example, the system may comprises thousands, hundreds of thousands or even millions of endpoint devices.

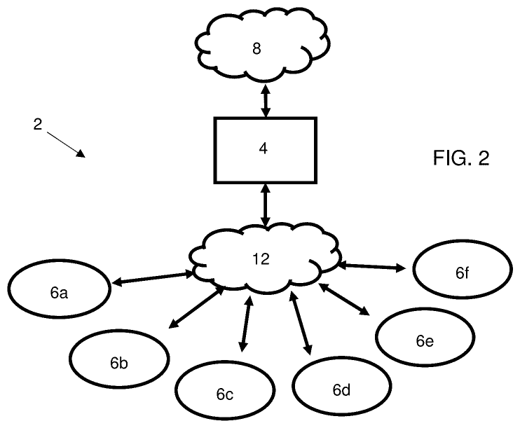

FIG. 2 schematically shows another exemplary system 2, which is implemented as a cellular system.

The system 2 shown in FIG. 2 is similar to that shown in FIG. 1A. As such, any features described in relation to the system 2 shown in FIG. 1A may also apply to the system 2 shown in FIG. 2. Only difference will be described in the following.

In the example shown in FIG. 2, each endpoint device 6a-6f connects to the head-end system 4 via the cellular network 12. As such, each endpoint device 6a-6f may be considered as defining a point-to-point connection with the head-end system 4. In this example, the system 2 does not comprise the gateway apparatus 10 shown in FIG. 1A.

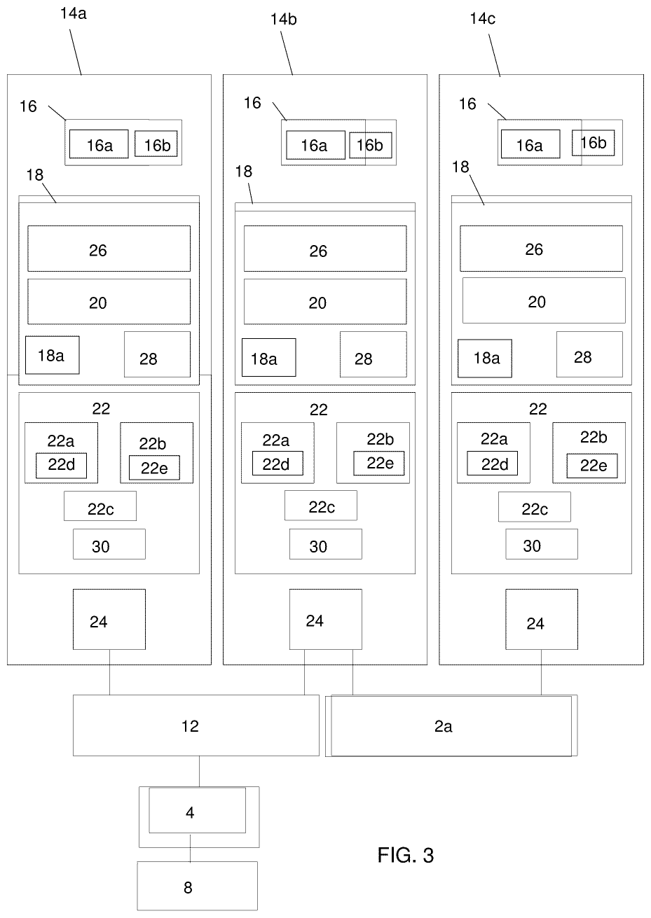

FIG. 3 schematically shows exemplary metering apparatuses 14a-14c. In the embodiment shown in FIG. 3, a first exemplary metering apparatus 14a is implemented as a cellular endpoint device, e.g. for use in the system 2 shown in FIG. 2. The first metering apparatus 14a is communicably connected to the cellular network 12. A second exemplary metering apparatus 14b is implemented as a gateway device 10, e.g. for use in the system 2 shown in FIG. 1A or FIG. 1B. The second metering apparatus 14b is communicably connected to the cellular network 12. A third exemplary metering apparatus 14c is implemented as an endpoint device of the wireless network 2a, e.g. as shown in FIG. 1A or FIG. 1B. The third metering apparatus 14c is communicably connected to the second metering apparatus 14b.

The first, second and third metering apparatuses 14a-14c are implemented in the same manner. As such, the same features of each of the first, second and third metering apparatuses 14a-14c will be described in the following with reference to the second metering apparatus 14b.

Referring to FIG. 3, the second metering apparatus 14b may be configured to meter and/or control a resource, such as electricity, water, gas or another resource. For example, the second metering apparatus 14b may comprise a metering controller 16. The metering controller 16 may comprise metering circuitry 16a configured to meter consumption of a resource, such as electricity, water, gas or another resource. The metering circuitry 16a may also be referred to as a metering application. The metering controller 16 may comprise a processing apparatus, such as a microcontroller or another processing device. The metering controller 16 may comprise one or more central processing units (CPU) and/or one or more digital signal processors (DSP). The metering controller 16 may also include a non-transitory computer-readable storage medium 16b, such as a volatile memory, e.g. random access memory (RAM), non-volatile memory, e.g. read-only memory (ROM) and/or electrically-erasable programmable ROM (EEPROM), and/or other hardware devices or component.

The metering circuitry 16a may be implemented in the CPU and/or DSP of the metering controller 16 by means of one or more computer programs having computer-readable instructions that are executable to perform one or more operations of the metering controller 16. The computer programs may be stored on the storage medium 16b. It will be appreciated that in other embodiments the metering circuitry may be implemented in software, hardware or any suitable combination of hardware and software. In some embodiments, the metering circuitry may be implemented as one or more ASICs (application specific integrated circuits) or FPGAs (field programmable gate arrays). The storage medium 16b may be accessible by the head-end system 4, e.g. to read data from the storage medium 16b and/or write data into the storage medium 16b.

The second metering apparatus 14b may comprise a control apparatus 18 configured to control and/or carry out one or more further operations of the second metering apparatus 14b. The control apparatus 18 may comprise a processing apparatus, such as a microcontroller or another processing device. The control apparatus 18 may comprise one or more central processing units (CPU) and/or one or more digital signal processors (DSP). The control apparatus 18 may also include a non-transitory computer-readable storage medium 18a, such as a volatile memory, e.g. random access memory (RAM), non-volatile memory, e.g. read-only memory (ROM) and/or electrically-erasable programmable ROM (EEPROM), and/or other hardware devices or component. The storage medium 18a may be accessible by the head-end system 4, e.g. to read data from the storage medium 18a and/or write data into the storage medium 18a.

The control apparatus 18 may comprise control circuitry 20 configured to control or determine various operating characteristics of the system 2. Although the control circuitry 20 of each of the first, second and third metering apparatuses 14a-14c may be implemented in the same manner, the control circuitry 20 may be configured to control different operations depending on whether the first, second and third metering apparatuses 14a-14c are each implemented as a cellular endpoint device, an endpoint device of a wireless network or a gateway device. For example, the control circuitry 20 of the first metering device 14a may be configured to transmit and/or receive the data to and/or from the head-end system 4, e.g. via the cellular network 12. The control circuitry 20 of the second metering apparatus 14b may also be configured to transmit and/or receive the data to and/or from the head-end system 4, e.g. via cellular network 12. The control circuitry 20 of the third metering device 14c may be configured to transmit and/or receive the data to and/or from the head-end system 4 via the gateway device 10, as shown in FIG. 1A or 1B. The control circuitry 20 may also be referred to as a head-end application.

The control circuitry 20 may be configured to control access to the resource, such as by a service disconnect switch or like. As such, the data transmitted by and/or received at the second metering apparatus 14b may comprise a control signal, such as a disconnect control signal or the like.

In this embodiment, the second metering apparatus 14b comprises a communications device 22 and an antenna 24, such as multiband antenna. The communications device 22 may be provided in the form of a modem, such as a multimode modem, or the like. The communications device 22 comprises a first connective mode and a second connective mode. In the first connective mode, the communications device 22 is configured to connect to a cellular network, such as the cellular network 12 shown in FIGS. 1A, 1B and 2, for transmission and/or reception of the data to and/or from the cellular network 12. The communications device 22 may be configured to use the antenna 24 for transmission and/or reception of the data to and/or from the cellular network 12.

In the second connective mode, the communications device 22 is configured to connect to the wireless network 2a, as shown in FIG. 1A and/or FIG. 1B, for transmission and/or reception of the data to and/or from the wireless network 2a. The communications device 22 may be configured to use the antenna 24 for transmission and/or reception of the data to and/or from the wireless network 2a.

The control apparatus 18 is configured to operate, e.g. adaptively operate, the communications device 22 in the first connective mode and/or the second connective mode, e.g. based on an availability of each of the cellular network 12 and/or the wireless network 2a and/or a connection priority assigned to each of the cellular network and/or the wireless network, as will be described in more detail below.

In this embodiment, the control apparatus 18 comprises communications circuitry 26 configured to control the communications device 22. The communications circuitry 26 may be configured to operate the communications device 22 in the first and/or second connective modes based on the availability of each of the cellular network 12 and/or the wireless network 2a and/or the connection priority assigned to each of the cellular network and/or the wireless network.

By configuring the communications circuitry 26 to operate the communications device 22 in the first connective mode and/or the second connective mode, the second metering apparatus 14b may be operated as a cellular endpoint device, an endpoint device of the wireless network 2a or a gateway device. The installation of a specific network device, such as a gateway device and/or a router, may be avoided, which in turn may reduce installation and/or maintenance costs of a wireless network. Additionally or alternatively, when installing the second metering apparatus 14b at a site, there may be no need to decide whether to install the metering apparatus as part of a cellular network or a wireless network. By configuring the communications circuitry 26 to operate the communications device 22 in the first connective mode and/or the second connective mode based on at least one of: the availability of each of the cellular network 12 and/or the wireless network 2a and/or the connection priority assigned to each of the cellular network 12 and/or the wireless network 2a, the communications circuitry 26 may be able to decide whether the second apparatus 14b becomes a part of the cellular system or the wireless network, e.g. based on the availability of each of the cellular network 12 and/or the wireless network 2a and/or the connection priority assigned to each of the cellular network 12 and/or the wireless network 2a. For example, a connection priority assigned to the wireless network 2a may be higher than a connection priority assigned to the cellular network 12. As such, the communications circuitry 26 may be configured to operate the communications device 22 in the second connective mode and/or to attempt a connection of the communications device to the wireless network 2a, e.g. before attempting a connection to the cellular network 12. This may allow for a reduction in connections to a cellular network, which in turn may reduce operational costs and/or provide an increased flexibility in a strategy for installing the metering apparatus.

Alternatively, the connection priority assigned to the cellular network 12 may be higher than the connection priority assigned to the wireless network 2a. As such, the communications circuitry 26 may be configured to operate the communications device 22 in the first connective mode and/or to attempt a connection of the communications device 22 to the cellular network 12, e.g. before attempting a connection to the cellular network. This may reduce a number of hops and/or a latency of a system comprising the apparatus and/or provide an increased flexibility in a strategy for installing the second metering apparatus 14b.

In the embodiment shown in FIG. 3, the communications device 22 may comprise one or more further CPUs and/or DSPs. For example, the communications device 22 comprises a first processing circuitry 22a that is configured to connect the communications device 22 to the cellular network 12. The communications device 22 may comprise a second processing circuitry 22b that is configured to connect the communications device 22 to the wireless network 2a. The first and second processing circuitries 22a, 22b may each comprise at least one of the further CPUs and/or DSPs. The control apparatus 18 may be communicably coupled to the communications device 22. As such, the communications circuitry 26 may be configured to control the operation of the first and second processing circuitries 22a, 22b. In other words, the communications circuitry 26 may comprise one or more instructions that when carried out by the control apparatus 18 cause the first and second processing circuitries 22a, 22b to connect the communications device 22 to the cellular network and/or the wireless network 2a, respectively.

The communications device 22 may comprise a physical layer 22c configured for the transmission and/or reception of the data to and/or from the second metering apparatus 14b, e.g. using the antenna 24. The physical layer 22c may be implemented as a PHY chip, other electronic circuitry or the like.

The communications device 22 may comprise one or more data link layers 22d, 22e. Each data link layer 22d, 22e may be considered as a protocol layer that transfers data to and/or from the second metering apparatus 14b across the physical layer 22c. For example, each data link layer 22d, 22e of the second metering apparatus 14b may be configured to provide the functional and procedural means to transfer data between the second metering apparatus 14b and another metering apparatus, such as the third metering apparatus 14c, and/or between the second metering apparatus 14b and the head-end system 4.

For example, the communications device 22 may comprise a first data link layer 22d. The first data link layer 22d may be configured to enable transfer of data via the cellular network 12, e.g. between the second metering apparatus 14b and the head-end system 4, across the physical layer 22c. The first data link layer 22d may be comprised in the first circuitry 22a. It will be appreciated that the first circuitry 22a may define or comprise further layers, e.g. network layer, application layer and/or one or more other communications layers, configured to enable transfer of data between the second metering apparatus 14b and the head-end system 4 via the cellular network 12.

The communications device 22 may comprise a second data link layer 22e. The second data link layer 22e may be configured to enable transfer of data via the wireless network 2a, e.g. between the second metering apparatus 14b and another metering apparatus, such as the third metering apparatus 14c, across the physical layers 22c. The second data link layer may be comprised in the second circuitry 22b. It will be appreciated that at least one of the further CPUs of the communications device 22 may be associated with each of the physical layer 22c, the first data link layer 22d and/or the second data link layer 22e.

In the embodiment shown in FIG. 3, the control apparatus 18 further comprises wireless networking circuitry 28. The wireless networking circuitry 28 may be communicably coupled to communications device 22, e.g. the second circuitry 22b. The wireless networking circuitry 28 may define or comprise further layers, e.g. a network layer, an application layer and/or one or more other communication layers. The wireless networking circuitry 28 is configured to allow for connection of the communications device 22 to the wireless network 2a and/or for transfer of data between second metering apparatus 14b and the other metering apparatus, such as the third metering apparatus 14c, via the wireless network 2a.

The cellular network 12 and the wireless network 2a may comprise similar modulation and/or data rates. For example, both the cellular network 12 and the wireless network 2a may use one or more frequency bands below 1 GHz, orthogonal frequency-division multiplexing (OFDM) and/or a modulation format, such as quadrature phase shift keying (QPSK) and/or a quadrature modulation (QAM), such as 16-QAM. A bandwidth of the cellular network 12 may be about 1.4 MHz and a maximum bandwidth of the wireless network 2a may be about 1.2 MHz. A maximum data rate of the cellular network may be about 1.1 Mbps. A maximum data rate of the wireless network may be 2.4 Mbps. This may allow for the use of a single physical layer 22c for the second metering apparatus 14b. This is turn may allow for the use of a single communications device to connect the second metering apparatus 14b to the cellular network 12 and/or the wireless network 2a, as described herein. This in turn may allow for reduced costs and/or a reduced complexity of the second meter apparatus 14b compared to a metering apparatus comprising a communications device for each connective mode. It will be appreciated that the cellular network and/or the wireless network are not limited to the exemplary frequency bands, modulation formats, bandwidths, data rates and/or use of OFDM described herein.

The control circuitry 20, communications circuitry 26 and wireless networking circuitry 28 may each be implemented in the CPU and/or DSP of the control apparatus 18 by means of one or more computer programs having computer-readable instructions that are executable to perform one or more operations of the control apparatus 18. The computer programs may be stored on the storage medium 18a. It will be appreciated that in other embodiments the control circuitry, communications circuitry wireless and networking circuitry may each be implemented in software, hardware or any suitable combination of hardware and software. In some embodiments, the various circuitries may be implemented as one or more ASICs (application specific integrated circuits) or FPGAs (field programmable gate arrays).

In this embodiment, the second metering apparatus 14b comprises a switching device 30. The switching device 30 may be provided in the form of a changeover switch, such as a single pole, double throw switch or the like. The switching device 30 may be part of the communications device 22. The switching device 30 may be configured to connect the physical layer 22c and the antenna 30 to either the first circuitry 22a or the second circuitry 22b. The communications circuitry 26 may be configured to control the switching device 30, e.g. to allow for operation of the communications device 22 in the first and/or second connective modes.

In the embodiment shown in FIG. 3, the communications circuitry 26 is configured to operate the communications device 22 in the first and/or second connective modes. As such, the second metering apparatus 14b may be implemented as a gateway device, a cellular endpoint device or an endpoint device of the wireless network. For example, the communications circuitry 26 may be configured to operate the communications device 22 in the first connective mode or the second connective mode. When the communications circuitry 26 operates the communications device 22 in the first connective mode, the second metering apparatus 14b is configured to operate as a cellular endpoint device or a gateway device. When the communications circuitry 26 operates the communications device 22 in the second connective mode, the second metering apparatus 14b is configured to operate as an endpoint device of the wireless network 2a.

When the communications circuitry 26 operates the communications device 22 in the first connective mode, the communications device 22 may also be configured to operate the communications device 22 in the second mode. When the communications circuitry 26 operates the communications device 22 in the first and second connective modes, the second metering apparatus 14b is configured to operate as the gateway device. However, it will be appreciated that in other embodiments, the communications circuitry may be configured to operate the communications device only in either the first connective mode or the second connective mode.

When the communications circuitry 26 is configured to operate the communications device 22 in the first and second connective modes, the communications circuitry 26 is configured to switch operation of the communications device 22 between the first and second connective modes, e.g. at a rate that allows for simultaneous, e.g. substantially simultaneous, connection of the communications device 22 to the cellular network 12 and the wireless network 2a. For example, the communications circuitry 26 may be configured to switch operation of the communications device 22 between the first and second connective modes at a rate between about 5 ms and 10 ms. This may allow the second metering apparatus 14b to operate as a gateway device, such as the gateway device 10, as shown in FIG. 1A or FIG. 1B.

However, it will be appreciated that in other embodiments, the communications circuitry may be configured to switch the operation of the communications device between the first and second connective modes differently. For example, the second metering apparatus may comprise a data buffer. The communications circuitry may be configured to switch the operation of the communications device between the first and second connective modes once a respective data buffer of the second metering apparatus is full, e.g. to transfer the data in the buffer to the head-end system and/or another metering apparatus, such as the third metering apparatus. In yet other embodiments, the communications circuitry may be configured to switch the operation of the communications device between the first and second connective modes based on a prioritization of data transfer between the second metering apparatus and the head-end system and/or the second metering apparatus and the other metering apparatus, such as the third metering apparatus.

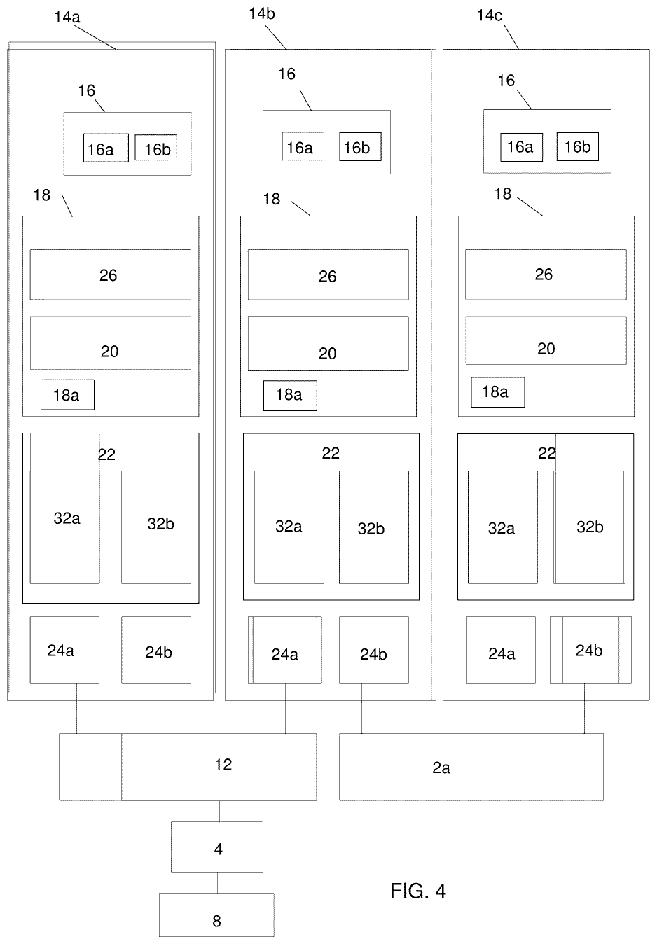

FIG. 4 schematically shows other exemplary metering apparatuses 14a-14c. The metering apparatuses shown in FIG. 4 are similar to the metering apparatuses 14a-14c shown in FIG. 3. As such, any features described in relation to the metering apparatuses 14a-14c shown in FIG. 3 may also apply to the metering apparatuses 14a-14c shown in FIG. 4. Only differences will be described in the following.

The metering apparatuses 14a-14c shown in FIG. 4 are implemented in the same manner. As such, the same features of each of the metering apparatuses 14a-14c will be described in the following with reference to the second metering apparatus 14b.

In the embodiment shown in FIG. 4, the communications device 22 of the second metering apparatus 14b comprises a first modem 32a. The first modem 32a comprises the first connective mode. The first modem 32a is implemented as a cellular modem, such as a LTE-M modem. The first modem 32a comprises all of the communications layers to enable transfer of data via the cellular network 12, e.g. between the second metering apparatus 14b and the head-end system 4.

The communications device 22 of the second metering apparatus 14b comprises a second modem 32b. The second modem 32b comprises the second connective mode. The second modem 32b is configured to connect to the wireless network 2a for transmission and/or reception of data to and/or from the wireless network 2a. For example, the second modem 32b comprises all of the communications layers to enable transfer of data via the wireless network 2a, e.g. between the second metering apparatus 14b and another metering apparatus, such as the third metering apparatus 14c. As such, in the embodiment shown in FIG. 4, the networking circuitry described above is part of the second modem 32b.

The second metering apparatus 14b comprises a first antenna 24a. The first antenna 24a is coupled to the first modem 32a, e.g. using a first connector (not shown), such as a coaxial connector or the like. The communications device 22 may be configured to use the first antenna 24a for transmission and/or reception of the data to and/or from the cellular network 12.

The second metering apparatus 14b comprises a second antenna 24b. The second antenna 24b is coupled to the second modem 32b, e.g. using a second connector (not shown), such as a coaxial connector or the like. The communications device 22 may be configured to use the second antenna 24b for transmission and/or reception of the data to and/or from the wireless network 2a.

The control apparatus 18 may be configured to simultaneously operate, e.g. substantially simultaneously operate, the communications device in the first and second connective modes.

It will be appreciated that in other embodiments, the second metering apparatus may comprise more than two antennas. For example, in such other embodiments more than one antenna may be coupled to the first modem and/or the second modem.

The following description refers to the second metering apparatus 14b, as described above in relation to FIG. 3 and/or FIG. 4. However, any of the features described in the following may also apply to the first and/or third metering apparatus 14a, 14c described above in relation to FIG. 3 and/or FIG. 4.

As described above, the communications circuitry 26 is configured to operate the communications device 22 in the first and/or second connective modes based on at least one of: the availability of each of the cellular network 12 and/or the wireless network 2a and/or the connection priority assigned to each of the cellular network 12 and/or the wireless network 2a.

The communications circuitry 26 may configured to operate the communications device 22 based on a setting of a control flag. The control flag may comprise a first setting and a second setting. In the first setting of the control flag, the communications circuitry 26 is configured to operate the communications device 22 based on the availability of each of the cellular network 12 and/or the wireless network 2a and/or the connection priority assigned to each of the cellular network 12 and/or the wireless network 2a. In the second setting of the control flag, the communications circuitry 26 is configured to operate the communications device 22 based on one or more system operator requirements. In other words, the communications circuitry 26 may be configured to operate the communications device 22 based on either at least one of: the availability of each of the cellular network 12 and/or the wireless network 2a and/or the connection priority assigned to each of the cellular network 12 and/or the wireless network 2a or the system operator requirements, e.g. in response to the setting of the control flag. The control flag may be set in the first or second setting at the time of manufacturing the second metering apparatus 14b. Additionally or alternatively, the control apparatus 18, e.g. the communications circuitry 26, may be configured to set the control flag in the first or second setting, e.g. during operation of the second metering apparatus, in response to a signal from the head-end system 4. The signal from the head-end system 4 may be indicative of the setting of the control flag.

The communications circuitry 26 may be configured to operate the communications device 22 based on network information. The network information may be stored in the storage medium 18a of the control apparatus 18 of the second metering apparatus 14b, e.g. in the form of a table. The control apparatus 18 may be configured to read data from and/or write data into the table. The storage medium 18a may also be accessible by the head-end system 4, e.g. to read data from and/or write data into the table.

Table 1 summarizes exemplary network information that may be stored in the storage medium 18a of the control apparatus 18 of the second metering apparatus 14b.

| | Connective | | | |
|---|---|---|---|---|
| Network | mode | Connection | Connection | Second |
| Identifier | indicator | timeout | priority | parameter |
| ID-A | Second mode | 10 min | 1 | 0 |
| ID-B | Second mode | 10 min | 1 | 0 |
| Vodafone | First mode | 5 min | 3 | 10 |
| AT&T | First mode | 5 min | 4 | 8 |
| Verizon | First mode | 5 min | 5 | 0 |

The network information may comprise a network identifier. The network identifier may be associated with one or more cellular networks and/or one or more wireless networks to which the communications device 22 may be connected. Each network identifier may include a name of a respective cellular network and/or wireless network. In this example, the network identifiers ID-A and ID-B are each associated with a respective wireless network and the network identifiers Vodafone, AT&T and Verizon are each associated with a respective cellular network.

The network information may comprise a connective mode indicator. The connective mode indicator is indicative of the connective mode of the communications device 22 that is required for connection to the cellular network and/or wireless network associated with the network identifiers. In other words, each network identifier is associated with a respective connective mode indicator.

The network information may include a connection timeout time associated with each of the cellular network and/or wireless network. The connection timeout time may be considered as a time duration during which the communications device 22 attempts to connect to a respective cellular network or wireless network, e.g. before attempting to connect to another cellular or wireless network. In the examples shown in Table 1, a connection timeout time associated with each of the wireless networks is selected to be longer than a connection timeout time associated with each of the respective cellular networks. However, in other embodiments the connection timeout time associated with at least one or each of the wireless networks may be selected to be same or shorter than a connection timeout time associated with at least one or each of the respective cellular networks. For example, the connection timeout time may be selected to increase a probability of a connection of the communications device 22 to at least one of the cellular network and wireless network relative to a connection of the communication device 22 of at least one other of the cellular network and wireless network. It will be appreciated that the connection timeout time is not limited to the exemplary values disclosed herein and that different values may be selected in other embodiments.

The network information may include the connection priority. Each network identifier is assigned or associated with a respective connection priority. As such, each of the cellular network and/or the wireless network associated with a respective network identifier is also assigned or associated with a respective connection priority. The connection priority is indicative of a priority of a connection with at least one of the cellular network and the wireless network relative to at least one other of the cellular network and the wireless network. In Table 1, a low value of the connection priority is indicative of a high priority of a connection to the cellular network or the wireless network assigned to or associated with the connection priority. The connection priority may be pre-determined, e.g. by a system operator. The connection priority may be selected based on a preference of a connection of the communications device 22 to the cellular network or the wireless network. For example, as described above, a connection priority assigned to a wireless network may be higher than a connection priority assigned to a cellular network. In the example shown in Table 1, the connection priority assigned to the wireless networks with the network identifiers ID-A and ID-B is higher than the connections priority assigned to the cellular network with the network identifiers Vodafone, AT&T and Verizon. Alternatively, the connection priority assigned to a cellular network may be higher than the connection priority assigned to a wireless network. The connection priority may be selected based on a preferred cellular network or wireless network for connection to the communications device. For example, in Table 1, the cellular network associated with the network identifier Vodafone has been assigned a higher connection priority, than the cellular network associated with the network identifier AT&T, which has been assigned with a higher connection priority than the cellular network associated with the network identifier Verizon. It will be appreciated that in other embodiments a different connection priority may be assigned to at least one or each of the cellular network and the wireless network.

The network information includes a second parameter. The second parameter may also be referred to as a parameter or further parameter. Each network identifier is associated with a respective second parameter. As such, each of the cellular network and/or the wireless network associated with a respective network identifier is also associated with a respective second parameter.

The second parameter is indicative of a quality of the associated cellular network and/or wireless network. The second parameter is also indicative of an availability of the associated cellular network and/or wireless network. For example, a second parameter larger than zero indicates that the cellular network and/or wireless network associated with the second parameter is available for connection to the communications device 22. The communications circuitry 26 may be configured to determine the second parameter. The second parameter may be determined differently for a cellular network compared to a wireless network. For example, the second parameter associated with a cellular network may be determined based on a Carrier to Interference plus Noise Ratio (CINR). The CINR may be indicative of a signal strength relative to noise in an environment. The second parameter associated with a wireless network may be determined based on one or more properties of the wireless network, such as a path loss between two or more nodes in the wireless network, a number of hops required between an endpoint device and a gateway device, a capacity of the gateway and/or the like. At the time of manufacturing a metering device, the second parameter associated with each of the cellular network and/or wireless may be set to zero. For example, as will be described below, the communications circuitry 26 may be configured to operate the communications device 22 to scan for the cellular network and/or the wireless network. When at least one of the wireless network and the cellular network is detected, the communications circuitry 26 is configured to determine the second parameter associated with the detected at least one of the wireless network and the cellular network.

The network identifier, connection timeout time and/or connection priority may be pre-determined or selected, e.g. based on one or more system operator requirements, e.g. prior to installation of the second metering apparatus 14b at a site.

For example, the system operator requirements may define that the communications device 22 of the second metering apparatus 14b is operated in the second connective mode, e.g. to minimize operational costs of the system. As such, at least one or each network identifier associated with a respective wireless network may be assigned or associated with a higher connection priority and/or longer connection timeout time than a connection priority and/or connection timeout time associated with at least one or each network identifier associated with a respective cellular network.

The system operator requirements may define that the communications device of the second metering apparatus is operated in the first connective mode, e.g. to minimize a number of hops, e.g. to reduce a latency of the system and/or to operate the second metering apparatus as a gateway device. As such, at least one or each network identifier associated with a respective wireless network may be assigned or associated with a lower connection priority and/or shorter connection timeout time than a connection priority and/or connection timeout time associated with at least one or each network identifier associated with a respective cellular network.

However, as mentioned above, the head-end system 4 may be configured to access the storage medium 18a of the control apparatus 18 of the second metering apparatus 14b. As such, the network identifier, connection timeout time and/or connection priority may be selected and/or changed, e.g. during operation of the second metering apparatus 14b, by the head-end system 4.

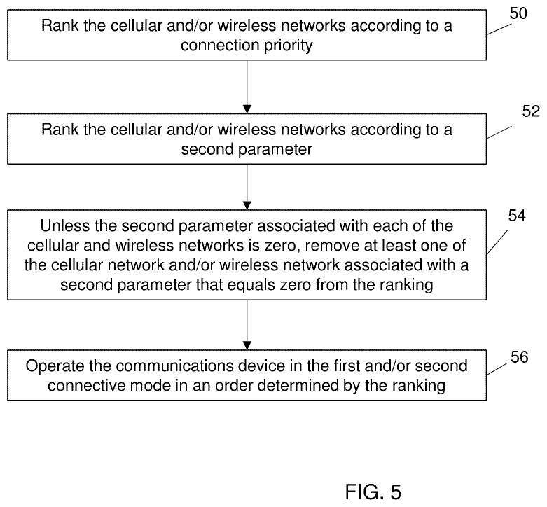

FIG. 5 is a flow chart illustrating in overview a process of operating a metering apparatus. The metering apparatus may comprise at least one of the first, second and third metering apparatuses 14a, 14b, 14c described above.

At stage 50, the cellular network and/or wireless network are ranked according to the connection priority assigned to each of the cellular network and/or wireless network. The cellular network and/or wireless network may be ranked in a descending order, e.g. from a highest connection priority to a lowest connection priority.

At stage, 52, the cellular network and/or wireless network are ranked according the second parameter. Stage 52 is performed subsequently to stage 50, e.g. to maintain the ranking of the cellular network and/or wireless network according to the connection priority. When the metering apparatus is first installed at a site, the second parameter associated with each of the cellular network and/or wireless network may be equal to zero.

Table 1 above shows an exemplary ranking of the cellular and wireless networks according to the first and second parameters. The connection priority may also be referred to as a first parameter.

At stage 54, at least one of the cellular network and/or wireless network associated with a second parameter that equals zero is removed from the ranking, unless the second parameter associated with each of the cellular network and wireless network is zero. For example, when the second parameter associated with at least one of the cellular network and wireless network is larger than zero and the second parameter associated with at least one other of the cellular network and the wireless network is zero, the at least one other of the cellular network and wireless network is removed from the ranking. This may ensure that the ranking only includes a cellular network and/or a wireless network that is available for connection to the communications device.

As described above, in some embodiments, the second parameter associated with each of the cellular network and/or wireless network may be equal to zero. In such examples, the communications circuitry is configured to maintain the cellular network and/or wireless network in the ranking. However, the cellular network and/or wireless network have been only ranked according to the connection priority assigned to each of the cellular network and/or wireless network. It will be appreciated that in other embodiments, the cellular network and/or wireless network may only be ranked according to the second parameter associated with each of the cellular network and/or wireless network.

Table 2 shows the ranking of the cellular and wireless networks shown in Table 1 with the cellular and wireless networks associated with a second parameter equal to zero having been removed.

| Network | Connective | Connection | Connection | Second |
|---|---|---|---|---|
| Identifier | modes | timeout | priority | parameter |
| Vodafone | First mode | 5 min | 3 | 10 |
| AT&T | First mode | 5 min | 4 | 8 |

At stage 56, the communications device is operated in the first connective mode or the second connective mode in an order determined by the ranking of the cellular network and/or the wireless network. The communications device is operated to attempt a connection to the cellular network or the wireless network in the order determined by the ranking of the cellular network and/or the wireless network. For example, the communications device may be operated in the first connective mode or the second connective mode associated with the highest ranked cellular or wireless network and attempt to connect the communications device to the highest ranked cellular or wireless network. In the example shown in Table 2, the communications device may be operated in the first mode to attempt a connection to the cellular network associated with the network identifier Vodafone. The communications device may be operated in the first mode to attempt a connection to this cellular network for the pre-determined duration defined by the connection timeout. When the connection attempt to this cellular network is unsuccessful, the communications device may be operated in the first connective mode to attempt a connection to the cellular network associated with the network identifier AT&T.

When no connection of the communications device 22 to the cellular network and/or wireless network in the ranking is established, stages 54 and 56 may be repeated. For example, stages 54 and 56 may be repeated until the communications device 22 is connected to at least one of the cellular network and wireless network.

When a connection of the communications device 22 to the cellular network and/or wireless network is establish, an already existing connection to another one of the cellular network and/or wireless network may be closed.

When the communications device 22 is connected to the cellular network, the metering apparatus is configured to operate as a cellular endpoint device or a gateway device. As described above, in some embodiments, the communications device is operated in either the first connective mode or the second connective mode. In such embodiments, the metering apparatus is configured to operate as the cellular endpoint device or the endpoint device of the wireless network. However, in embodiments, where the communications device is operated in the first and second connective modes, the metering apparatus is configured to operate as a gateway device.

When the communications device 22 is connected to the wireless network, the metering apparatus is configured to operate as an endpoint of the wireless network.

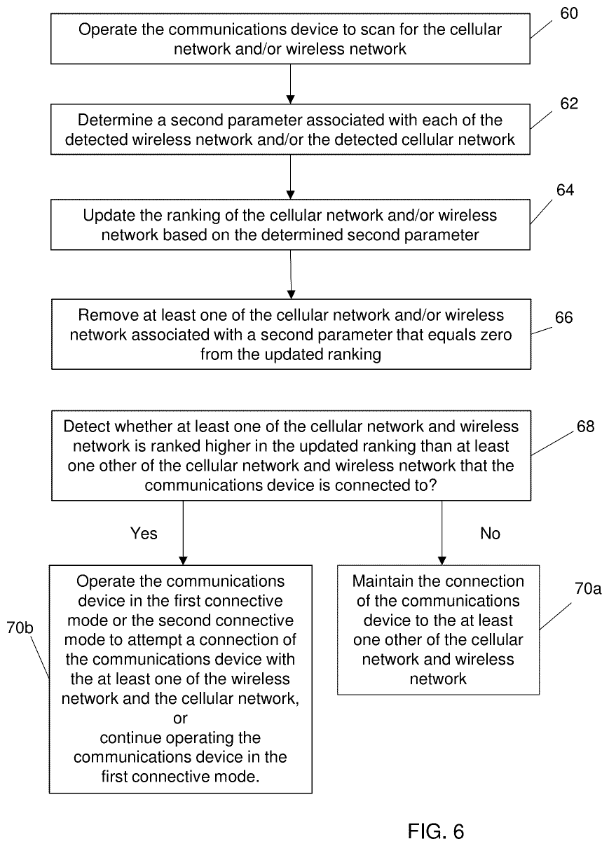

FIG. 6 is a flow chart illustrating in overview another process of operating the metering apparatus. The metering apparatus may comprise at least one of the first, second or third metering apparatuses 14a, 14b, 14c described above.

In the following description, the communications device 22 may be connected to at least one of the cellular network and the wireless network. However, it will be appreciated that one or more of the following stages may be performed, when connection of the communications device to at least one of the cellular network and the wireless network is established.

At stage 60, the communications device 22 is operated to scan for the cellular network and/or the wireless network.

When the wireless network and/or the cellular network is detected, a second parameter associated with the detected wireless network and/or the detected cellular network is determined. For example, the wireless network and/or cellular network may be detected based on the network identifier associated with the wireless and/or cellular network. The network identifier may be comprised in a packet received by the communications device 22 from the wireless network and/or the cellular network. When the network identifier corresponds to a network identifier associated with a cellular and/or wireless network in the ranking, the second parameter associated with the detected wireless network and/or the detected cellular network is determined.

At stage 62, when the wireless network and/or the cellular network is detected, a second parameter associated with each of the detected wireless network and/or the detected cellular network is determined.

At stage 64, the ranking of the cellular network and/or wireless network is updated based on the determined second parameter.

At stage 66, at least one of the cellular network and/or wireless network associated with a second parameter that equals zero is removed from the updated ranking, as described above in relation to stage 54.

At stage 68, it is detected whether at least one of the cellular network and/or wireless network is ranked higher in the updated ranking than the at least one other of the cellular network and wireless network that the communications device 22 is connected to. For example, the at least one of the cellular network and wireless network may be ranked the highest in the updated ranking.

At stage 70a, when the at least one of the cellular network and wireless network ranks lower in the updated ranking than the at least one other of the cellular network and wireless network that the communications device is connected to, the connection of the communications device to the at least one other of the cellular network and wireless network is maintained.

At stage 70b, when the at least one of the cellular network and wireless network is ranked higher in the updated ranking than the at least one other of the cellular network and wireless network that the communications device is connected to, the operation of the communications device in the first connective mode is continued, when the metering apparatus operates as a gateway and an endpoint device is connected to the metering apparatus. This may prevent an interruption of a connection between the gateway device and the endpoint device.

Alternatively, the communications device is operated in the first connective mode or the second connective mode to attempt a connection of the communications device to the at least one of the wireless network and the cellular network. This may allow for a connection of the communications device to a cellular or wireless network having a higher or even the highest priority. However, the connection of the communications device 22 to the at least one other of the cellular network and wireless network may be closed.

For example, the communications device 22 may be operated in the first connective mode and be connected to the cellular network associated with the network identifier AT&T. However, the ranking of the cellular network and/or wireless network has been updated, as described above, and the cellular network associated with the network identifier Vodafone is ranked higher than the cellular network associated with the network identifier AT&T. In this example, the communications device 22 is operated in the first connective mode to attempt a connection to the cellular network associated with the network identifier Vodafone. It will be appreciated that in other examples, a wireless network may be ranked higher than the cellular network or wireless network the communications device is connected to. When the metering apparatus operates as a gateway and an endpoint device is connected to the metering apparatus, the communications device continues to operate in the first connective mode, as described above. However, in examples where the metering apparatus operates as an endpoint device, e.g. a cellular endpoint device or an endpoint device of a wireless network, the communications device is operated in the second connective mode to attempt a connection to the higher ranked wireless network. As such, the communications device is adaptively operated in the first and/or second connective modes based on the availability of each of the cellular and/or the wireless network and/or the connection priority assigned to each of the cellular network and/or the wireless network.

In some embodiments, the communications device is operated in the first connective mode and/or the second connective mode based on one or more system operator requirements. The communication circuitry 26 may be configured to operate the communications device 22 based on the system operator requirements.

For example, in response to control flag being set in the second setting, the communications device is operated in the first connective mode and/or the second connective mode based on the system operator requirements. In such embodiments, the system operator requirements may be considered as overwriting the operation of the communications device based on the availability of each of the cellular and/or wireless network and/or the connection priority assigned to each of the cellular network and/or the wireless network.

For example, the system operator requirements may define that the communications device of the metering apparatus is operated in the second connective mode, e.g. to minimize operational costs of the system. The system operator requirements may define that the communications device of the metering apparatus is operated in the first connective mode, e.g. to minimize a number of hops, e.g. to reduce a latency of the system. The system operator requirements may define that the communications device of the metering apparatus is operated in the first and second connective modes, e.g. so that the metering apparatus operates as a gateway device of the system. The system operator requirements may be defined by an operator of the system, e.g. prior or after installation of the system. This may allow for optimization of the system, e.g. to reduce latency and/or operational costs, prior or after installation of the system.

The system operator requirements may be stored in the storage medium 18a of the control apparatus 18. The communications circuitry 26 may be configured to access the system operator requirements in the storage medium. The storage medium 18a may be accessible by the head-end system 4, e.g. to read data from the storage medium 18a and/or write data into the storage medium 18a. The storage medium 18a may be accessible by the head-end system 4, e.g. to change the system operator requirements. This may allow for manual operation of the communications device 22 by the system operator.

It will be appreciated that any of the process steps described in relation to FIG. 6 may be performed in addition to or instead of any of the process steps described in relation to FIG. 5. It will also be appreciated that any of the process steps described herein may be performed in a different order than that described in relation to FIGS. 5 and/or 6.

The communications circuitry of at least one or each of the first, second and third metering apparatuses described herein may be configured to perform any of the process steps described above in relation to FIGS. 5 and/or 6.

It will be understood that references to a plurality of features may be interchangeably used with references to singular forms of those features, such as for example “at least one” and/or “each”. Singular forms of a feature, such as for example “at least one” or “each,” may be used interchangeably.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Although the disclosure has been described in terms of particular embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

1. A metering apparatus comprising:
a communications device comprising a first connective mode and a second connective mode, wherein in the first connective mode, the communications device is configured to connect to a cellular network for transmission and/or reception of data to and/or from the cellular network and in the second connective mode, the communications device is configured to connect to a wireless network for transmission and/or reception of data to and/or from the wireless network, the wireless network being configured to use one or more unlicensed frequency bands below 1 GHz; and
a control apparatus configured to adaptively operate the communications device in the first connective mode and/or the second connective mode based on at least one of:
an availability of each of the cellular network and/or the wireless network; and
a connection priority assigned to each of the cellular network and/or the wireless network,
wherein the control apparatus is configured to rank the cellular network and/or the wireless network according to the connection priority assigned to each of the cellular network and/or the wireless network and according to a second parameter associated with each of the cellular network and/or the wireless network, the second parameter being indicative of the availability and a quality of each of the cellular network and/or the wireless network.

2. The apparatus of claim 1, wherein when the communications device is operated in the first connective mode and connected to the cellular network, the apparatus is configured to operate as a cellular endpoint device or a gateway device.

3. The apparatus of claim 1, wherein when the communications device is operated in the second connective mode and connected to the wireless network, the apparatus is configured to operate as an endpoint of the wireless network.

4. The apparatus of claim 1, wherein the control apparatus is configured to operate the communications device in the first connective mode or the second connective mode and to attempt a connection of the communications device to the cellular network or the wireless network in an order determined by a ranking of the cellular network and/or the wireless network.

5. The apparatus of claim 1, wherein the control apparatus is configured to rank the cellular network and/or wireless network according to the connection priority prior to ranking the cellular network and/or wireless network according to the second parameter.

6. The apparatus of claim 1, wherein the control apparatus is configured to operate the communications device to scan for the cellular network and/or the wireless network.

7. The apparatus of claim 6, when the wireless network and/or the cellular network is detected, the control apparatus is configured to determine a second parameter associated with each of the detected the cellular network and/or the wireless network.

8. The apparatus of claim 7, wherein the control apparatus is configured to update the ranking of the cellular network and/or the wireless network based on the determined second parameter associated with each of the detected cellular network and/or the wireless network.

9. The apparatus of claim 8, wherein the control apparatus is configured to operate the communications device in the first connective mode or the second connective mode and to attempt a connection of the communications device to the cellular network or the wireless network in an order determined by the updated ranking of the cellular network and/or the wireless network.

10. The apparatus of claim 9, wherein when the control apparatus detects that at least one of the cellular network and the wireless network is ranked higher in the updated ranking than at least one other of the cellular network and wireless network that the communications device is connected to, the control apparatus is configured to:
continue operating the communications device in the first connective mode, when the apparatus operates as a gateway and an endpoint device is connected to the apparatus; or
operate the communications device in at least one of the first connective mode and second connective modes to attempt a connection of the communications device to the at least one of the wireless network and the cellular network.

11. The apparatus of claim 10, wherein the at least one of the cellular network and the wireless network is ranked the highest in the updated ranking.

12. The apparatus of claim 8, wherein the control apparatus is configured to remove at least one of the cellular network and the wireless network associated with a second parameter that equals zero from the ranking and/or the updated ranking, unless a second parameter associated with each of the cellular network and/or wireless network equals zero.

13. The apparatus of claim 1, wherein the control apparatus is configured to operate the communications device in the first connective mode and/or the second connective mode based on one or more system operator requirements, and optionally the operation of the communications device based on the one or more system operator requirements overwriting the operation of the communications device based on the at least one of: the availability of each of the cellular network and/or the wireless network and/or the connection priority assigned to each of the cellular network and/or the wireless network.

14. The apparatus of claim 1, wherein the communications device comprises at least one of:
a modem comprising the first and second connective modes; or
a first modem comprising the first connective mode and a second modem comprising the second connective mode.

15. A metering apparatus comprising:
a communications device comprising a first connective mode and a second connective mode, wherein in the first connective mode, the communications device is configured to connect to a cellular network for transmission and/or reception of data to and/or from the cellular network and in the second connective mode, the communications device is configured to connect to a wireless network for transmission and/or reception of data to and/or from the wireless network, the wireless network being configured to use one or more unlicensed frequency bands below 1 GHz; and
a control apparatus configured to adaptively operate the communications device in the first connective mode and/or the second connective mode based on at least one of:
an availability of each of the cellular network and/or the wireless network; and/or
a connection priority assigned to each of the cellular network and/or the wireless network.

16. A system comprising:
a plurality of metering apparatuses, each of the plurality of metering apparatuses comprising a metering apparatus according to claim 15.

17. The system of claim 16, wherein at least one apparatus of the plurality of metering apparatuses is operated in the first or second connective mode and/or at least one other apparatus is operated in the first and second connective modes.

18. A method of operating a metering apparatus according to claim 1, the method comprising:
ranking the cellular network and/or the wireless network according to a connection priority assigned to each of the cellular network and/or the wireless network and according to a second parameter associated with each of the cellular network and/or the wireless network, the second parameter being indicative of an availability and a quality of each of the cellular network and/or the wireless network; and
adaptively operating the communications device in the first connective mode and/or the second connective mode based on at least one of:
the availability of each of the cellular network and/or the wireless network; and
the connection priority assigned to each of the cellular network and/or the wireless network.

19. A method of operating a metering apparatus according to claim 15, the method comprising:
adaptively operating the communications device in the first connective mode and/or the second connective mode based on at least one of:
an availability of each of the cellular network and/or the wireless network; and/or
a connection priority assigned to each of the cellular network and/or the wireless network.

20. A computer program having computer executable instructions to cause the metering apparatus to execute the method of claim 18.
